(19) United States
(12) Patent Application Publication
(10) Pub. No.: US 2025/0106532 A1
(43) Pub. Date: Mar. 27, 2025

(54) SIGNAL PROCESSING DEVICE, SENSOR DEVICE, SIGNAL PROCESSING METHOD, AND PROGRAM

(71) Applicant: Sony Interactive Entertainment Inc., Tokyo (JP)

(72) Inventors: Naoki Egawa, Kanagawa (JP); Hiromasa Naganuma, Chiba (JP); Masakazu Hayashi, Tokyo (JP)

(73) Assignee: Sony Interactive Entertainment Inc., Tokyo (JP)

(21) Appl. No.: 18/730,880

(22) PCT Filed: Jan. 31, 2022
(86) PCT No.: PCT/JP2022/003473

§ 371 Date: Jul. 22, 2024

(51) Int. Cl. H04N 25/47; H04N 25/62; H04N 25/779

(52) U.S. Cl. CPC H04N 25/47; H04N 25/62; H04N 25/779

(57) ABSTRACT

Provided is a signal processing device including a transmission determining section that determines whether or not to transmit an event signal output from a vision sensor which is of an event-driven type and which includes a plurality of sensors constituting a sensor array, on the basis of position information for each of the sensors in the sensor array.

### TECHNICAL FIELD

The present invention relates to a signal processing device, a sensor device, a signal processing method, and a program.

### BACKGROUND ART

There are known event-driven vision sensors in which pixels that have detected changes in the intensity of incident light generate signals in a time-asynchronous manner. Event-driven vision sensors have an advantage of being able to operate with low power and at high speed compared to frame-type vision sensors that scan all pixels at predetermined time intervals, specifically, image sensors such as a charge coupled device (CCD) and a complementary metal oxide semiconductor (CMOS). Techniques related to such event-driven vision sensors are described in PTL 1 and PTL 2, for example.

### CITATION LIST

### Patent Literature

[PTL 1] Japanese Translations of PCT for Patent No. 2014-535098, [PTL 2] Japanese Patent Laid-open No. 2018-85725

### SUMMARY

### Technical Problem

Since the event-driven vision sensor described above has high resolution both temporally and spatially, the vision sensor outputs a large amount of event signals including signals caused by noise. Depending on the type of processing based on event signals, a load on transmission and operation for such a large amount of signals may become excessive, but no solution to such cases has been proposed.

Therefore, an object of the present invention is to provide a signal processing device, a sensor device, a signal processing method, and a program that can reduce the load on event signal transmission and operation.

### Solution to Problem

According to one aspect of the present invention, provided is a signal processing device including a transmission determining section that determines whether or not to transmit an event signal output from a vision sensor which is of an event-driven type and which includes a plurality of sensors constituting a sensor array, on the basis of position information for each of the sensors in the sensor array.

According to another aspect of the present invention, provided is a sensor device including a vision sensor that is of an event-driven type and includes a plurality of sensors constituting a sensor array, an image processing section that performs image processing on the basis of an event signal output from the vision sensor, and a region specifying section that specifies a region on the basis of a result of the image processing, and the vision sensor is configured to output the event signal only for the specified region.

According to yet another aspect of the present invention, provided is a signal processing method including a step of determining whether or not to transmit an event signal output from a vision sensor that is of an event-driven type and includes a plurality of sensors constituting a sensor array, on the basis of position information for each of the sensors in the sensor array.

According to yet another aspect of the present invention, provided is a program for causing a computer to implement a function of determining whether or not to transmit an event signal output from a vision sensor that is of an event-driven type and includes a plurality of sensors constituting a sensor array, on the basis of position information for each of the sensors in the sensor array.

### BRIEF DESCRIPTION OF DRAWINGS

FIG. 1 is a diagram illustrating a schematic configuration of a system according to a first embodiment of the present invention.

FIG. 2 is a diagram for illustrating an example of transmission determination in the first embodiment of the present invention.

FIG. 3 is a diagram illustrating a schematic configuration of a system according to a second embodiment of the present invention.

FIG. 4 is a diagram for illustrating an example of transmission determination in the second embodiment of the present invention.

FIG. 5 is a diagram illustrating an example of a data path in the second embodiment of the present invention.

FIG. 6 is a diagram illustrating a schematic configuration of a sensor device according to a third embodiment of the present invention.

FIG. 7 is a diagram for illustrating an example of transmission determination in the third embodiment of the present invention.

FIG. 8 is a diagram illustrating a schematic configuration of a sensor device according to a fourth embodiment of the present invention.

FIG. 9 is a diagram for illustrating an example of transmission determination in the fourth embodiment of the present invention.

FIG. 10 is a diagram illustrating examples of segment shapes applicable to each of the embodiments of the present invention described above.

### DESCRIPTION OF EMBODIMENTS

Preferred embodiments of the present invention will be described in detail below with reference to the accompanying drawings. Note that, in the present description and the drawings, components having substantially the same functional configuration are specified by the same reference signs and redundant description will be omitted.

### First Embodiment

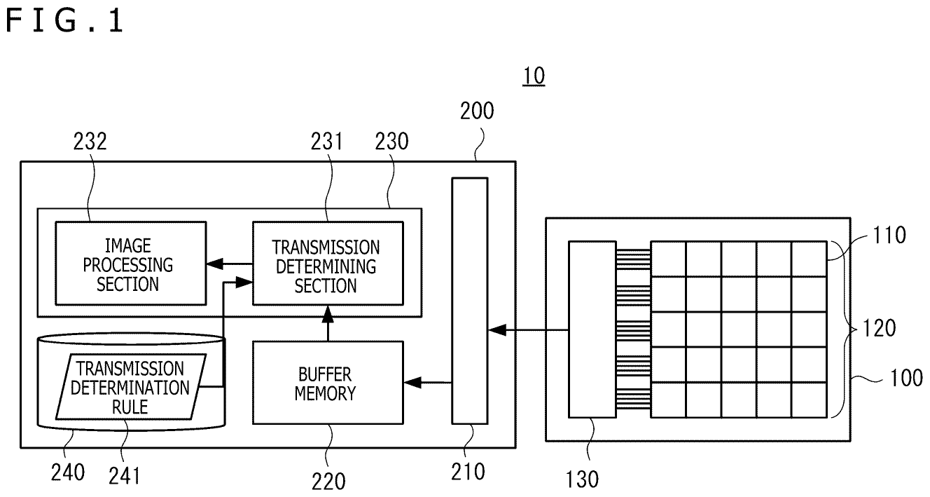

FIG. 1 is a diagram illustrating a schematic configuration of a system according to a first embodiment of the present invention. In the illustrated example, a system 10 includes an event driven sensor (EDS) 100, which is a vision sensor of an event-driven type, and a signal processing device 200.

The EDS 100 includes a sensor array 120 having a plurality of sensors 110 and a sensor control unit 130 connected to the sensor array 120. The sensors 110 each include a light receiving element and generate an event signal when detecting a change in the intensity of incident light, more specifically, when detecting a change in brightness. In an image in which event signals are mapped on the basis of the address of each of the sensors 110 in the sensor array 120, each of the sensors 110 corresponds to a pixel. In the following description, a region corresponding to the entire sensor array 120 in the above image is also referred to as a pixel area, and a region corresponding to each sensor 110 is also referred to as a pixel. However, when the event signal is read from the sensor 110 according to the address generated by an address generating device included in the sensor control unit 130, since reading from the sensor 110 that has not detected an event is not executed, the event signals are output from the EDS 100 in a time-asynchronous manner.

The signal processing device 200 includes a communication interface 210, a buffer memory 220, an operation unit 230, and a storage unit 240. The communication interface 210 receives an event signal from the sensor control unit 130 of the EDS 100. The received event signal is temporarily stored in the buffer memory 220. The operation unit 230 is implemented, for example, by a processor that operates according to a program stored in the storage unit 240 and processes event signals read from the buffer memory 220.

In the present embodiment, the operation unit 230 includes a transmission determining section 231 and an image processing section 232 as functional parts achieved by operation according to a program. The transmission determining section 231 determines whether or not to transmit the event signal to the image processing section 232, as in an example to be described later, for example. In other words, all event signals temporarily stored in the buffer memory 220 are not necessarily transmitted to the image processing section 232. The image processing section 232 performs various types of image processing on the basis of the event signal transmitted from the buffer memory 220 according to the determination by the transmission determining section 231. For example, the image processing section 232 may generate time-series images made by mapping positions where brightness changes occur, and perform such processing as tracking or optical flow calculation for an object on the images. The storage unit 240 stores a transmission determination rule 241 that are to be referenced by the transmission determining section 231.

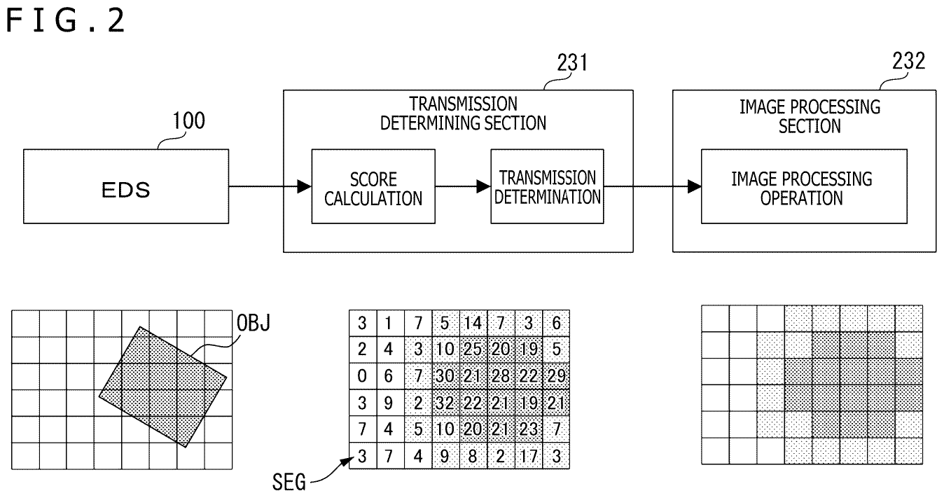

FIG. 2 is a diagram for illustrating an example of transmission determination in the first embodiment of the present invention. In the illustrated example, the transmission determining section 231 calculates a score for each segment (SEG) that includes a plurality of pixels and that is obtained by dividing the pixel area into a predetermined number of segments, on the basis of the event signal output from the EDS 100. As described above, pixel areas correspond to the sensor array 120 and sensors 110 correspond to pixels, so that a segment is defined within the sensor array 120 and includes the plurality of sensors 110. For example, in a case where pixels are arranged in two orthogonal directions, a rectangular area of 6 pixels×6 pixels may be used as one segment. The transmission determining section 231 calculates a score by adding up the numbers of event signals for each segment, and transmits, to the image processing section 232, the event signals output from the segment and adjacent segments, in a case where the score exceeds a threshold value. Incidentally, the score of the segment for which the transmission has been executed is reset.

In the illustrated example, an event signal is transmitted in a case where the number of event signals exceeds half the number of pixels in the segment (6×6÷2=18). In a segment that overlaps or is in the vicinity of an object (OBJ) which is present in a pixel area, the output of an event signal is relatively increased compared with in other areas. On the other hand, event signals are output even in segments unrelated to the object, due to noise and other factors, but their number is relatively small. The transmission determining section 231 distinguishes event signals in each of the object portion and other portions on the basis of position information for each sensor 110 in the sensor array 120, and determines whether or not to transmit each event signal. Therefore, with the above configuration, it is possible to suppress the transmission of event signals of segments unrelated to the object and reduce the load on event signal transmission and on image processing operation in the image processing section.

In the above example, the transmission determining section 231 may attenuate or reset the score of each segment at predetermined time intervals. For example, in a case where the number of event signals of each segment is added up without time limit, there is a possibility that the number of event signals due to noise or the like may reach the threshold value after taking a long time, even in segments unrelated to the object. By attenuating or resetting the score for segments whose number of event signals has not reached the threshold value for a long time, the load on transmission and image processing operation for event signals caused by noise can be further reduced.

In the processing of the transmission determining section 231 as described above, the shape and number of segments obtained by dividing a pixel area as well as the score calculation method and threshold value for each segment are stored in the storage unit 240 as the transmission determination rule 241. Here, a plurality of different criteria may be defined in the transmission determination rule 241, depending on conditions related to image processing performed by the image processing section 232, for example. For example, in a case where it is desired to reduce the amount of data transmission in the processing in the image processing section 232 or in the processing performed after processing results are further transmitted to another device, the threshold value for determination in the transmission determining section 231 may be increased. Conversely, in a case where it is desired to improve responsiveness rather than reduce the amount of data transmission, the threshold value for determination in transmission determining section 231 may be reduced. Further, when the sizes of a plurality of segments are defined, the threshold value may be set according to the size of the segment, that is, the number of pixels included in the segment. To be specific, a larger threshold value may be set for a segment with a large size, and a smaller threshold value may be set for a segment with a small size.

### Second Embodiment

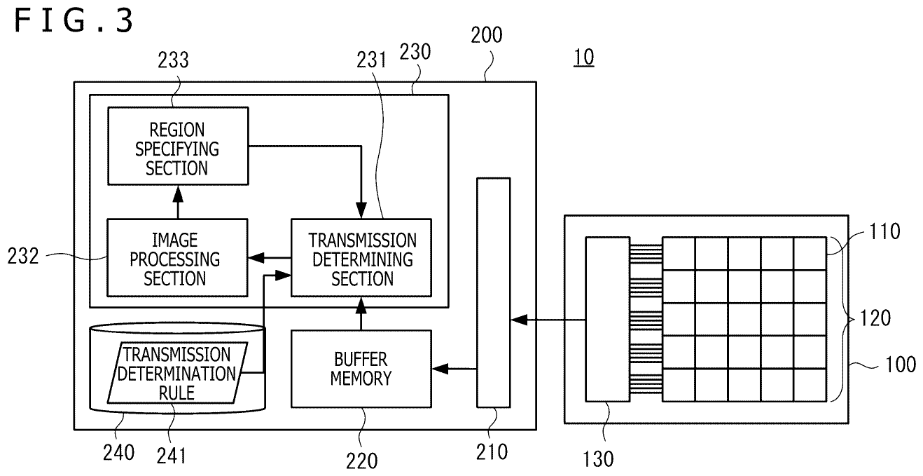

FIG. 3 is a diagram illustrating a schematic configuration of a system according to a second embodiment of the present invention. As a difference from the first embodiment described above, in the present embodiment, the operation unit 230 of the signal processing device 200 includes a region specifying section 233 in addition to the transmission determining section 231 and the image processing section 232 as a functional part achieved by operation according to a program. The region specifying section 233 specifies the region for which the event signal is to be transmitted, on the basis of a result of image processing in the image processing section 232, as in the example described below. It is to be noted that the configuration other than this is similar to that of the first embodiment described above, so that a redundant detailed description is omitted.

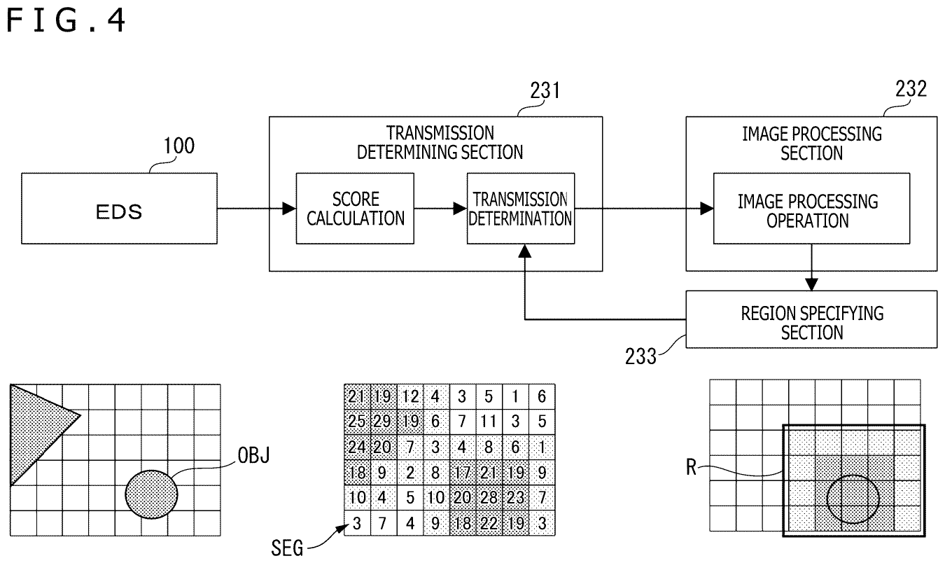

FIG. 4 is a diagram for illustrating an example of transmission determination in the second embodiment of the present invention. In the illustrated example, the transmission determining section 231 calculates a score for each segment (SEG) into which the pixel area is divided, similarly to the example of the first embodiment described above. On the other hand, the region specifying section 233 specifies a region (R) for which the event signal is to be transmitted, on the basis of the result of the image processing performed by the image processing section 232. The region (R) may be a region that overlaps the object (OBJ) at least partially or includes the object, for example. Further, the region (R) may be a region corresponding to a region of interest (ROI) in tracking or optical flow calculation, for example. The transmission determining section 231 calculates a score for each segment by adding up the number of output event signals. In a case where the score exceeds the threshold value and the segment is included in the specified region (R), the transmission determining section 231 transmits the event signals output in the segment and adjacent segments, to the image processing section 232.

It should be noted that, in the illustrated example, although the transmission determining section 231 calculates scores for all segments and then determines whether or not to transmit the event signal, on the basis of whether the segment is included in the specified region (R), the transmission determining section 231 may calculate the score only for segments included in the specified region (R), in other examples. In either case, the transmission determining section 231 determines whether or not to transmit the event signal output from the sensor 110 for which the transmission determining section has position information regarding a position within the specified region (R).

In the illustrated example, there are two objects (OBJ) in the pixel area, and the output of event signals is relatively high in segments overlapping these objects, compared with in other regions. In the first embodiment described above, in such a case, event signals respectively generated for both objects are transmitted from the transmission determining section 231 to the image processing section 232. On the other hand, in the present embodiment, since the region (R) required for image processing in the image processing section 232 is specified in advance by the region specifying section 233, the event signal generated for the object that is not the target object among the two objects is not transmitted from the transmission determining section 231 to the image processing section 232. In a case where the region (R) required for image processing in the image processing section 232 can be specified in advance, the above configuration can further reduce the load on event signal transmission and image processing operation in the image processing section.

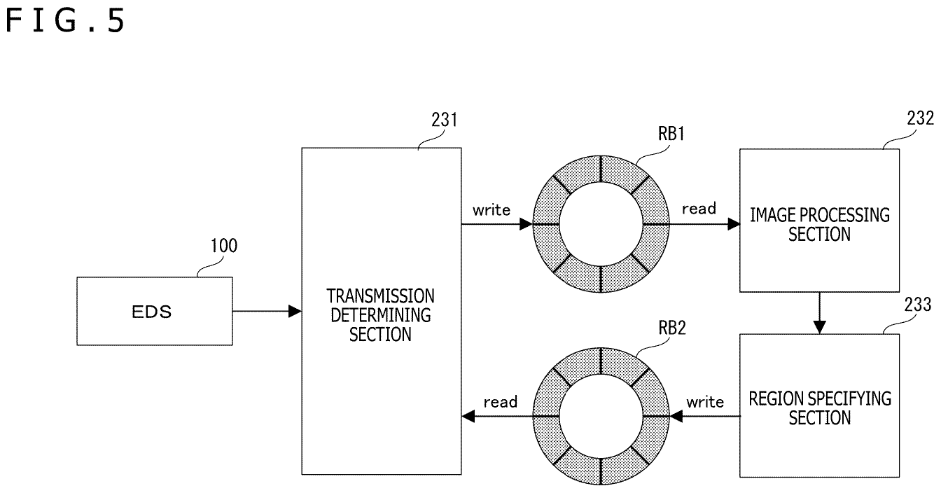

FIG. 5 is a diagram illustrating an example of a data path in the second embodiment of the present invention. In the present embodiment, the transmission of an event signal from the transmission determining section 231 to the image processing section 232 and the transmission of information for specifying a region from the region specifying section 233 to the transmission determining section 231 can be implemented by a queue using ring buffers RB1 and RB2 as illustrated in the figure. Such a data path can be used for transmitting event signals and for transmitting information for specifying regions in other embodiments.

### Third Embodiment

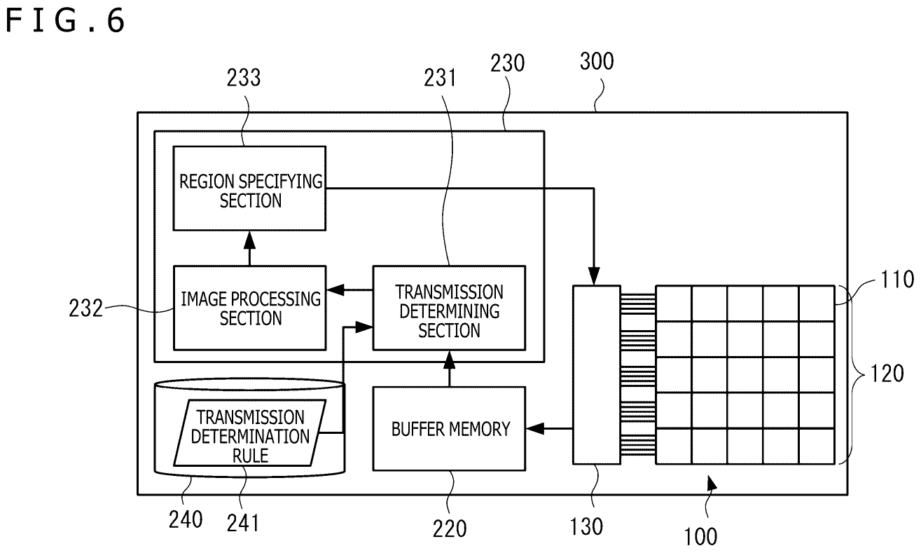

FIG. 6 is a diagram illustrating a schematic configuration of a sensor device according to a third embodiment of the present invention. In the present embodiment, the sensor array 120 including the sensors 110, which are components of the EDS, and the sensor control unit 130 are incorporated in a sensor device 300 (in the following description, there is a case where these parts will be referred to as the EDS 100 for convenience). Therefore, the output of an event signal from the sensor control unit 130 and the input of information for specifying a region into the sensor control unit 130, which will be described later, are not carried out through communication between devices via a communication interface, but through communication within a device via a bus interface or the like. Note that the configuration other than this is similar to that of the second embodiment described above, so that a redundant detailed description is omitted.

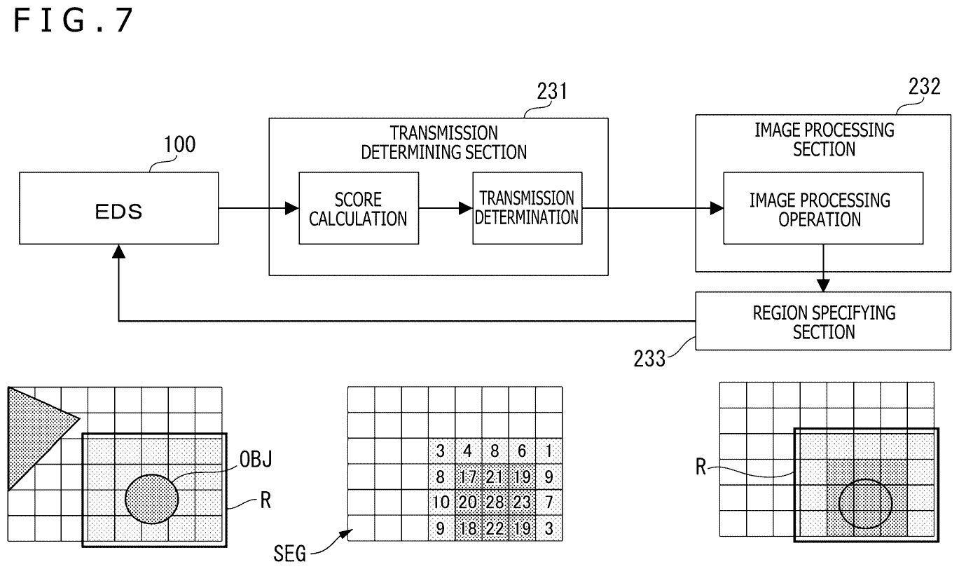

FIG. 7 is a diagram for illustrating an example of transmission determination in the third embodiment of the present invention. In the present embodiment, the region specifying section 233 inputs, to the EDS 100, information specifying the region (R) for which the event signal is to be transmitted, and the EDS 100 outputs the event signal only for the specified region (R). To be specific, the sensor control unit 130 executes reading of the event signal only for the specified region (R). The transmission determining section 231 calculates a score for each segment (SEG) obtained by dividing the pixel area, as in the above first embodiment, but an event signal is not output in areas other than the region (R) specified by the region specifying section 233, and as a result, the score is calculated only for the segment of the specified region (R). In a case where the score of a segment exceeds a threshold value, event signals output from the segment and adjacent segments are transmitted to the image processing section 232. Similarly to the second embodiment described above, the region specifying section 233 specifies the region (R) for which the event signal is to be transmitted, on the basis of the result of the image processing performed by the image processing section 232. The region (R) may be a region that overlaps the object (OBJ) at least partially or includes the object, for example. Further, the region (R) may be a region corresponding to a ROI in tracking or optical flow calculation, for example.

In the illustrated example as well, two objects (OBJ) are present in the pixel area, as in the example described above with reference to FIG. 4. Although, in the example of FIG. 4, the event signals generated for both objects are output from the EDS 100, the region specifying section 233 specifies the region (R) for which the event signal is output from the EDS 100 in the present embodiment, so that an event signal generated for an object that is not a target object among two objects is not output from the EDS 100 in the first place. In this way, similarly to the second embodiment described above, in a case where the region (R) required for image processing in the image processing section 232 can be specified in advance and the operation unit 230 and the sensor control unit 130 can interlock with each other in the sensor device 300, the above configuration can further reduce the load on event signal transmission and image processing operation in the image processing section. To be specific, not only the load on the transmission from the transmission determining section 231 to the image processing section 232 but also the load on the output of the event signal from the sensor control unit 130 and the transmission to the transmission determining section 231 can be reduced.

### Fourth Embodiment

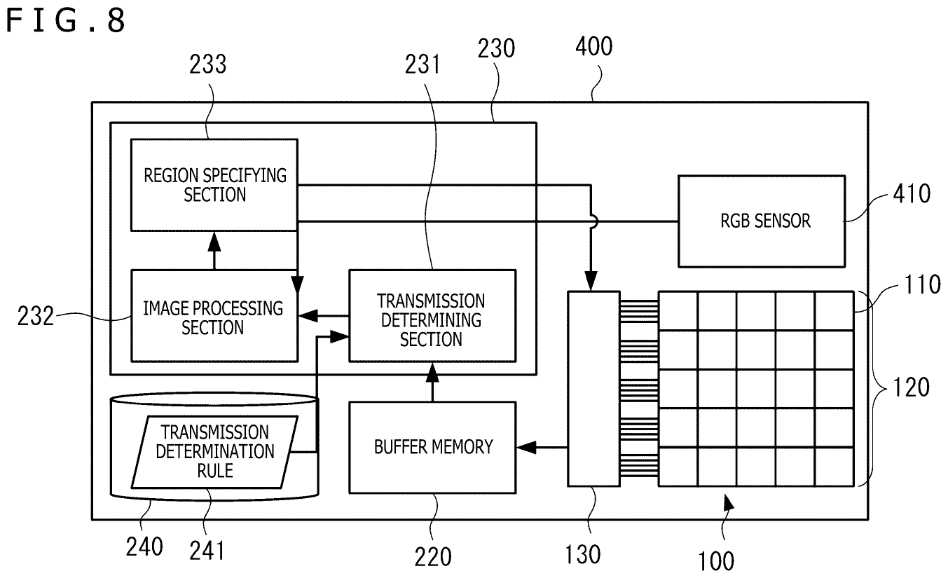

FIG. 8 is a diagram illustrating a schematic configuration of a sensor device according to a fourth embodiment of the present invention. In the present embodiment, an RGB sensor 410 is further incorporated into a sensor device 400 similar to that in the third embodiment, and the image processing section 232 performs image processing using image signals output from the RGB sensor 410 in addition to image processing using the event signal output from the EDS 100. The region specifying section 233 specifies a region for which an event signal is to be transmitted, mainly on the basis of the result of image processing using an image signal. Incidentally, since the configuration other than this is similar to that of the third embodiment described above, a redundant detailed description will be omitted.

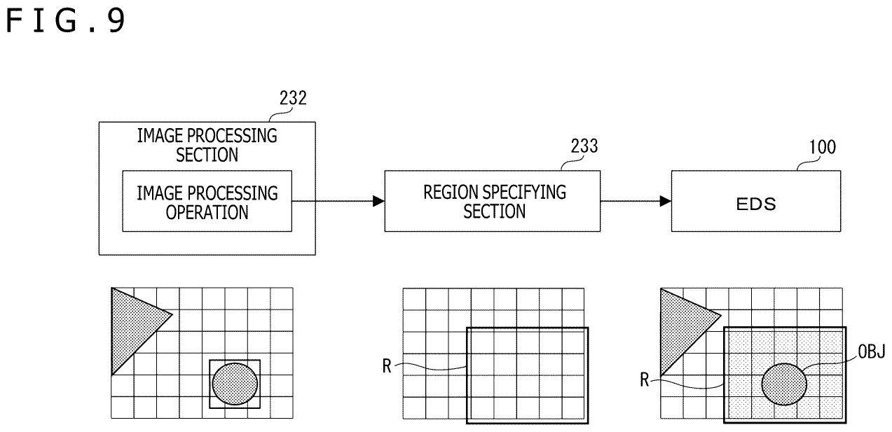

FIG. 9 is a diagram for illustrating an example of transmission determination in the fourth embodiment of the present invention. In the present embodiment, the region specifying section 233 specifies the region (R) for which an event signal is to be transmitted, on the basis of the result of image processing such as object detection performed by the image processing section 232 on the basis of the image signal input from the RGB sensor 410. The region specifying section 233 inputs information specifying the target region (R) to the EDS 100, and the EDS 100 outputs event signals only for the specified region (R). As a result, as in the example of FIG. 7 above, the event signal generated for the object other than the target object among the two objects (OBJ) which are present in the pixel area is not output from the EDS 100, and the event signal generated for the target object in the region (R) is transmitted from the EDS 100 to the image processing section 232. Note that, in a case where the event signals to be transmitted to the image processing section 232 can be selected by control of the EDS 100 as in the present embodiment, the score calculation and transmission determination processing in the transmission determining section 231 do not necessarily have to be performed.

### Example of Segment Shape

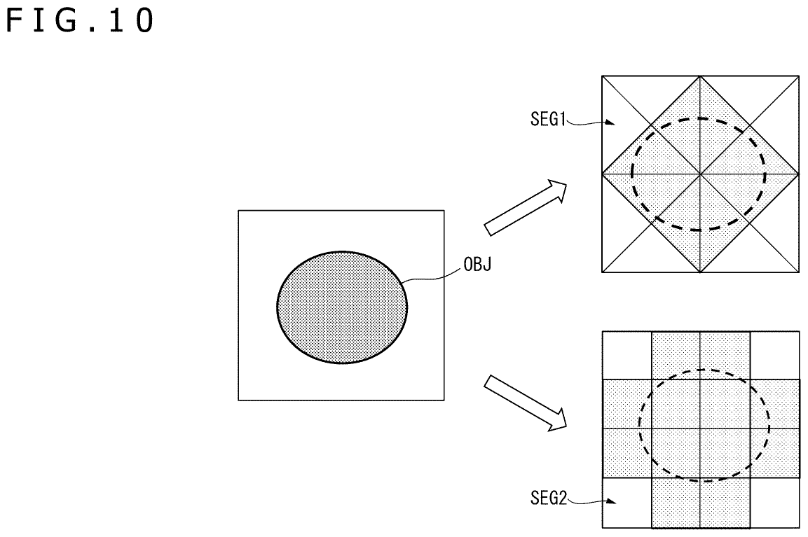

FIG. 10 is a diagram illustrating examples of segment shapes applicable to each embodiment of the present invention described above. In the above description, a rectangular area of 6 pixels×6 pixels is used as one segment in a case where pixels are arranged in two orthogonal directions, but the shape of the segment is not limited to the above example. For example, the number of pixels constituting one segment may be different for each direction in which the pixels are arranged, and specifically, one segment may be a rectangular area of 10 pixels×5 pixels. Further, the segment does not necessarily have to be a rectangular area, and may be a triangular area like SEG1 in the example illustrated in FIG. 10, for example. In this example, for a spherical object (OBJ), the triangular segment SEG1 can capture the object with a smaller number of segments than the rectangular segment SEG2 which is obtained by dividing the same area into the same number of segments (8 segments out of 16 segments for SEG1, 12 segments out of 16 segments for SEG2). In this way, by defining the shape of the segment by combining boundary lines parallel to the directions in which pixels are arranged and boundary lines oblique to those directions, objects of various shapes can be captured with fewer segments.

Although the preferred embodiments of the present invention have been described above in detail with reference to the accompanying drawings, the present invention is not limited to such examples. It is obvious that a person with ordinary knowledge in the technical field to which the present invention pertains can come up with various examples of modifications or amendments within the scope of the technical idea described in the claims, and it is understood that these also fall within the technical scope of the present invention.

### REFERENCE SIGNS LIST

10: System
110: Sensor
120: Sensor array
130: Sensor control unit
200: Signal processing device
210: Communication interface
220: Buffer memory
230: Operation unit
231: Transmission determining section
232: Image processing section
233: Region specifying section
240: Storage unit
241: Transmission determination rule
300: Sensor device
400: Sensor device
410: RGB sensor

1. A signal processing device comprising:
a transmission determining section that determines whether or not to transmit an event signal output from a vision sensor which is of an event-driven type and which includes a plurality of sensors constituting a sensor array, on a basis of position information for each of the sensors in the sensor array.

2. The signal processing device according to claim 1, wherein the transmission determining section determines whether or not to transmit the event signal, on a basis of a score calculated for each segment that is defined within the sensor array and includes a plurality of the sensors.

3. The signal processing device according to claim 2, wherein the transmission determining section calculates the score by adding up the number of event signals for each segment.

4. The signal processing device according to claim 3, wherein the transmission determining section attenuates or resets the score at predetermined time intervals.

5. The signal processing device according to claim 2, wherein the segment is defined by combining a boundary line parallel to a direction in which the sensors are arranged and a boundary line oblique to the direction.

6. The signal processing device according to claim 1, further comprising: an image processing section that performs image processing on a basis of the transmitted event signal.

7. The signal processing device according to claim 6, wherein the transmission determining section determines whether or not to transmit the event signal, on a basis of a criterion different depending on a condition regarding the image processing.

8. The signal processing device according to claim 6, further comprising:
a region specifying section that specifies a region on a basis of a result of the image processing,
wherein the transmission determining section determines whether or not to transmit the event signal output from the sensor for which the transmission determining section has the position information regarding a position within the specified region.

9. The sensor device according to claim 8, wherein the region specifying section specifies a region that overlaps an object at least partially or that includes the object.

10. The sensor device according to claim 8, wherein:
the image processing section executes tracking or optical flow calculation for an object, and
the region specifying section specifies a region corresponding to a region of interest in the tracking or the optical flow calculation.

11. A sensor device comprising:
a vision sensor that is of an event-driven type and includes a plurality of sensors constituting a sensor array;
an image processing section that performs image processing on a basis of an event signal output from the vision sensor; and
a region specifying section that specifies a region on a basis of a result of the image processing, wherein
the vision sensor is configured to output the event signal only for the specified region.

12. The sensor device according to claim 11, wherein the region specifying section specifies a region that overlaps an object at least partially or that includes the object.

13. The sensor device according to claim 11, wherein:
the image processing section executes tracking or optical flow calculation for an object, and
the region specifying section specifies a region corresponding to a region of interest in the tracking or the optical flow calculation.

14. The sensor device according to claim 11, further comprising: a transmission determining section that determines whether or not to transmit the event signal to the image processing section, on a basis of position information for each of the sensors in the sensor array.

15. The sensor device according to claim 14, wherein the transmission determining section determines whether or not to transmit the event signal, on a basis of a score calculated for each segment that is defined within the sensor array and includes a plurality of the sensors.

16. The sensor device according to claim 11, wherein:
the image processing section performs the image processing further on a basis of an image signal output from a sensor different from the vision sensor, and
the region specifying section specifies the region on a basis of a result of the image processing performed based on the image signal.

17. A signal processing method comprising: determining whether or not to transmit an event signal output from a vision sensor that is of an event-driven type and includes a plurality of sensors constituting a sensor array, on a basis of position information for each of the sensors in the sensor array.

18. A non-transitory computer readable storage medium containing a program that causes a computer to implement a method comprising: determining whether or not to transmit an event signal output from a vision sensor that is of an event-driven type and includes a plurality of sensors constituting a sensor array, on a basis of position information for each of the sensors in the sensor array.
